(19) United States
(12) Patent Application Publication
(10) Pub. No.: US 2008/0126661 A1
(43) Pub. Date: May 29, 2008

(54) Apparatus for alternative user-interface for a smart communication or computing device in a motor vehicle

(75) Inventors: Rocky Lin, Irvine, CA (US); Brian Wang, Irvine, CA (US)

Correspondence Address: QUINN EMANUEL;KODA & ANDROLIA, 865 S. FIGUEROA STREET, 10TH FLOOR, LOS ANGELES, CA, 90017, US

(73) Assignee: Zandiant Technologies, Inc.

(21) Appl. No.: 11/374,595

(22) Filed: Mar. 13, 2006

(51) Int. Cl. G06F 13/00

(52) U.S. Cl. 710/304

(57) ABSTRACT

An apparatus for interfacing communication and computing devices to a vehicle's entertainment system, data system, and/or vehicle's diagnostics system to minimize driver distraction and to integrate the latest computing technologies for entertainment, information, and applications to the vehicle. Such an interface may be provided by hardware, firmware or software provided in the vehicle, computing and communication devices or both. The interface not only provides a link but also translates the data, commands and responses of one to data, commands and responses understandable by the other.

### BACKGROUND OF THE INVENTION

1. Field of the Invention

This invention relates generally to the field of automotive electronics, and more particularly to interfacing portable communication, entertainment and computing devices such as cellular phone's, MP3 players or PDA's to an automotive environment with an objective to reduce driver distraction, and simplify the user interface experience.

2. Prior Art

In an automobile environment, the driver must be alert and not distracted while operating the automobile. However, as the proliferation of computing capabilities and communication devices such as cellular phones and PDA's become more prevalent, they are introduced into the automobile environment. The introduction of complex computing and communication devices has caused drivers to become distracted while trying to operate these complex devices and drive an automobile at the same time.

One of the issues of why these portable communication and computing devices cause such a distraction is due to the innate design of these devices. The cellular phones were originally designed to be portable. The display is designed to be as compact as possible and display as much information in as little space as possible. The keys are also designed to occupy as little space as possible.

Another issue of why these portable communication and computing devices cause distractions is because of the complexity of the devices. As computing technology advances, many of these portable computing devices integrate more and more features that the user may want to utilize. By having many functions available, the driver must cycle through numerous menus and key pressing just to activate a feature.

The system and apparatus of U.S. Pat. Nos. 6,711,474 and 6,526,335 use an automotive personal computer to address the issue of computing devices in the automobile. However, this involves designing a computing system for the automotive environment.

### SUMMARY OF THE INVENTION

Accordingly, a need has arisen the need to interface complex portable communication, entertainment and computing devices in the car to minimize driver distraction. Therefore, it is an object of the present invention to provide a method and apparatus that substantially reduces the amount of driver distraction when utilizing these devices in the vehicle.

Accordingly it is a general object of this invention to allow the user to enjoy the same functionality inside the automotive environment as outside while reducing the cost. As both in-car device and portable device functionality are advancing, there are many duplicated complex functionality in both types of devices. Some advanced features in the existing information and entertainment devices in the automotive environment can be eliminated and offloaded into the portable communication and computing devices. In this way, the cost for the built-in device can be reduced, but the functionality of the devices combined is still as powerful if not more.

It is another object of this invention to prevent duplication and centralize control of the collected personalized information.

As technology advances, many people have the same set of personal contact information, favorite photos, MP3 songs, family video clips duplicated in their computers, PDAs, mobile phones, and even inside their vehicle. Accordingly, it is another object of this invention to allow users to enjoy these types of information residing in the mobile phone through the in-car device while driving.

This invention addresses the problem by providing a simple user interface so that the user may be able to access complex computing, communication and entertainment devices during the operation of the motor vehicle. The complex devices may be a personal digital assistant (PDA), MP-3 players advanced cellular phone, laptop, or any electronic device capable of computing data for entertainment or information. As these devices mature, they incorporate more and more features. These features may sometimes be utilized by the driver of automobiles as a navigational aid, informational aid, or an entertainment device. These portable devices are designed for portability, as a result the user interface (keyboard and display) are limited to a small physical space. These small displays and keys are not easily utilized by the driver during the operation of a motor vehicle. The invention is an apparatus that interfaces these portable computing, communication and entertainment devices to the automotive environment to allow for simpler operation in the automotive environment. The means to interface the vehicle environment may be a wired or a wireless. The portable computing communication and entertainment device may interface with the automotive environment via the dashboard, the entertainment console, or some other display or interface projected on the windshield.

The invention is an apparatus that replaces the user interface on these devices with an interface to the automotive environment to allow for simpler operation in the automotive environment. The connection to the vehicle environment may be a wired or a wireless. For example, the alternative display of computing device can be displayed in the vehicle's entertainment console. This entertainment console may be a liquid crystal display (LCD) that is installed in the vehicle. The user may observe the status of the computing device on the LCD rather than the small display that is present on the computing device. The user may then utilize the alternative interface on the entertainment console to control the computing device. The interfaces are not limited to just the physical buttons, but also the touch screen LCD display. By allowing the driver to interact with this larger display and control of the entertainment console, the amount of distraction can be minimized. The driver is more familiar with the entertainment console than fumbling for small buttons on small devices such as a cellular phone, laptop, MP3 player or PDA.

### BRIEF DESCRIPTION OF THE DRAWINGS

In keeping with the principles and objects, the present invention will be described in conjunction with the following figures wherein like reference numerals denote like elements and in which:

FIG. 1 is a block diagram of the present invention illustrating the apparatus interfacing an automotive entertainment console; and

FIG. 2 is a flow diagram illustrating the operation of the present invention.

### DETAILED DESCRIPTION OF THE INVENTION

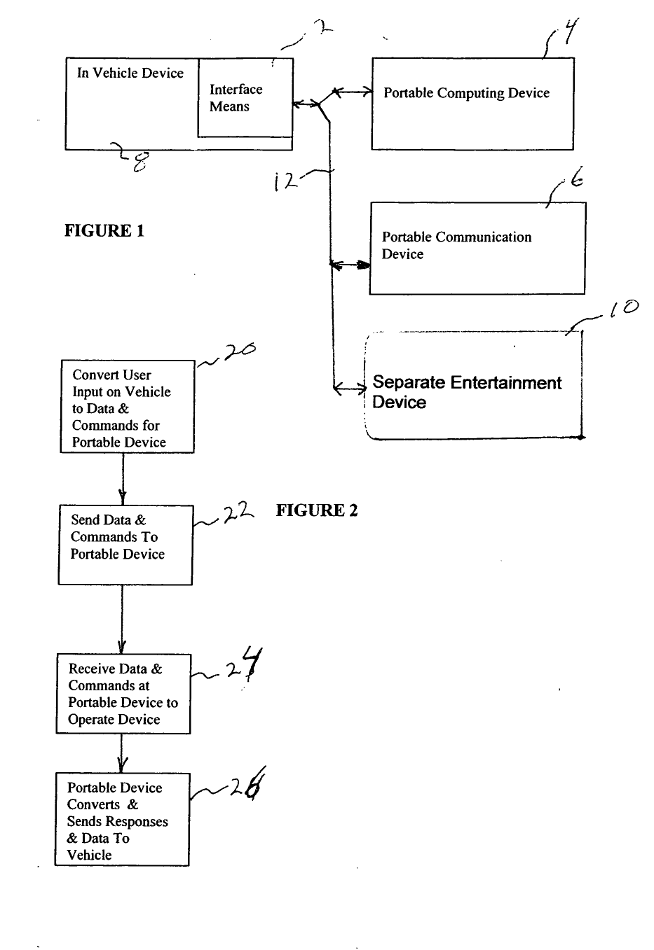

One embodiment of the preset invention and its advances is best understood by referring now in more detail to FIGS. 1 and 2. FIG. 1 shows a block diagram of how the apparatus or interface 2 showing how the system would integrate with current automotive environment and FIG. 2 shows a flow diagram illustrating how the apparatus or interface 2 operates and interfaces with portable devices such as computing, communicating and/or separate entertainment devices 4,6 and 10, respectively. The interface 2 would interface with a in vehicle device 8 such as the automobile's entertainment console as part thereof, an addition to or a vehicle accessory. This entertainment console could be a radio, compact disc player, DVD video player, etc. The entertainment console would have a liquid crystal display that is capable of displaying information. The entertainment console would also have keys that allow the user to interact with the entertainment console. The entertainment console may also have a touch screen liquid crystal display, which will allow the user to touch the screen to control the entertainment console.

This entertainment console already address some of the user interface issues by keeping the user interface relatively simple to use and relatively large in size so the driver may interact with the entertainment console 8 while driving. The apparatus 2 would allow this entertainment console 8 to control the portable computing, separate entertainment and/or communicating devices 4,6 and 10 respectively, such as a PDA, cellular phone, laptop, MP3 player, etc. These devices 4, 6 and 10 may be accessed via wireless and/or wired means 12. Examples of wireless means 12 may be 802.11 WiFi, Bluetooth, etc. The entertainment console 8 will be able to control and display content that is generated/stored on the portable computing, communication and/or separate entertainment devices 4, 6 and 10 respectively.

Referring to FIG. 2, shown therein is a flow diagram illustrating the operation of the interface 2 and the system in general. The steps of the flow diagram of FIG. 2 may be implemented by hardware, software and/or firmware provided in the interface 2 and/or portable devices 4,6 and 10 or external to either. The creation and implementation of this hardware, software and/or firmware is within the skill of one of ordinary skill in the art and is therefore not explicitly set forth herein. In addition, much of this can be handled by the Bluetooth standards.

In step 20, the operator of the vehicle inputs commands or data to the entertainment console 8 via the operational buttons and/or touch screen display screen and the inputted commands and/or data is converted to data and/or commands for the portable devices 4, 6 and/or 10, respectively. The converted commands and/or data is sent to the portable devices 4, 6 and/or 10, respectively, in step 22. In step 24, the data and/or commands are received by the portable devices 4, 6 and/or 10, respectively, and are used by the portable devices to store data, make a communication connection or operate to provide entertainment to the vehicle occupants.

In step 26, the portable devices 4, 6 and/or 10 will respond by sending data, status and/or commands to the entertainment console 8. The data may be the contents of a telephone call from the communication device 6 or music from the separate entertainment device 10 to be provided over the entertainment console 8. The data may also be information to be displayed to the driver by the entertainment console 8 from the portable computing device 4.

It should be apparent to those skilled in the art that the above described embodiment is one of many embodiments which can be implemented by one of ordinary skill in the art without departing from the spirit and scope of the invention.

What is claimed is:

1. An apparatus for interfacing at least one portable device with a vehicle system having display and data entry means, said apparatus comprising:
means for converting user input on said vehicle system into information to said at least one portable device;
means for transmitting said information to said portable device and for transmitting information to said vehicle system from said portable device;
a means for receiving said information and providing said information in a portable device usable format to said portable device; and
means for generating said information from said portable device to said vehicle system.

2. The apparatus according to claim 1 wherein said vehicle system is selected from the group consisting of an entertainment system and a data system.

3. The apparatus according to claim 1 wherein said at least one portable device is one or more devices selected from the group consisting of personal data assistance (PDA), laptop, MP3 players and cell phones.

4. The apparatus according to claim 1 wherein said means for transmitting is selected from the group consisting of wired and wireless.

5. The apparatus according to claim 4 wherein said wireless is selected from the group consisting of WIFI, 802.11 and Bluetooth.

6. The apparatus according to claim 1 wherein said apparatus is provided by hardware, software, firmware or a combination of at least two which is provided in the vehicle system, portable device or both.

7. An apparatus for alternative user interface replacement on computing devices to a vehicle entertainment system.

8. An apparatus for alternative user interface replacement on a computer device to a vehicle data system.
